(19) United States
(12) Patent Application Publication
(10) Pub. No.: US 2019/0389761 A1
(43) Pub. Date: Dec. 26, 2019

(54) GLASS MATERIAL AND METHOD FOR MANUFACTURING SAME

(71) Applicant: NIPPON ELECTRIC GLASS CO., LTD., Otsu-shi, Shiga (JP)

(72) Inventor: Futoshi SUZUKI, Otsu-shi (JP)

(21) Appl. No.: 16/478,510

(22) PCT Filed: Feb. 16, 2018
(86) PCT No.: PCT/JP2018/005550

§ 371 Date: Jul. 17, 2019

(30) Foreign Application Priority Data
Mar. 9, 2017 (JP) 2017-045021
Nov. 22, 2017 (JP) 2017-224588

(51) Int. Cl. C03C 3/068; C03C 23/00

(52) U.S. Cl. CPC C03C 3/068; C03C 2201/34; C03C 23/007

(57) ABSTRACT

Provided is a glass material having high light transmittance at operating wavelengths. A glass material containing, in terms of oxide by mole %, 5 to 40% Tb₂O₃ and being substantially free of Sb₂O₃ and As₂O₃, wherein a proportion of Tb³⁺ to a total amount of Tb is 55% by mole or more.

### TECHNICAL FIELD

The present invention relates to a glass material suitable for a magneto-optical element making up part of a magnetic device, such as an optical isolator, an optical circulator or a magnetic sensor, and a method for manufacturing the same.

### BACKGROUND ART

Glass materials containing terbium oxide which is a paramagnetic compound are known to exhibit the Faraday effect which is one of magneto-optical effects. The Faraday effect is the effect of rotating the polarization plane of linearly polarized light passing through a material placed in a magnetic field. This effect is utilized in magneto-optical devices, including optical isolators and magnetic field sensors.

The optical rotation θ (the angle of rotation of the polarization plane) due to the Faraday effect is expressed by the following formula where the intensity of a magnetic field is represented by H and the length of a substance through which polarized light passes is represented by L. In the formula, V represents a constant dependent on the type of the substance and is referred to as a Verdet constant. The Verdet constant takes positive values for diamagnetic substances and negative values for paramagnetic substances. The larger the absolute value of the Verdet constant, the larger the absolute value of the optical rotation, resulting in exhibition of greater Faraday effect.

θ=VHL

Glass materials exhibiting the Faraday effect are conventionally known, such as SiO₂—B₂O₃—Al₂O₃—Tb₂O₃-based glass materials (see Patent Literature 1), P₂O₅—B₂O₃—Tb₂O₃-based glass materials (see Patent Literature 2), and P₂O₅—TbF₃—RF₂— (where R represents an alkaline earth metal) based glass materials (see Patent Literature 3).

### CITATION LIST

### Patent Literature

[PTL 1]

JP-B-S51-46524

[PTL 2]

JP-B-S52-32881

[PTL 3]

JP-B-S55-42942

### SUMMARY OF INVENTION

### Technical Problem

Although the above glass materials exhibit some degree of Faraday effect, recent increasing size reduction of magnetic devices requires further improvement of the Faraday effect so that even a small member can exhibit a sufficient optical rotation. In order to increase the Faraday effect, it is effective to increase the content of Tb in the glass material. However, in this case, the light transmittance at operating wavelengths (for example, 300 to 1100 nm) tends to decrease, which presents a problem that the resultant magnetooptic device has a poor light extraction efficiency.

In view of the above, an object of the present invention is to provide a glass material having high light transmittance at operating wavelengths.

### Solution to Problem

A glass material according to the present invention contains, in terms of oxide by mole %, 5 to 40% Tb₂O₃ and is substantially free of Sb₂O₃ and As₂O₃, wherein a proportion of Tb³⁺ to a total amount of Tb is 55% by mole or more. Since the proportion of Tb³⁺ to the total amount of Tb in the glass is large, the glass material has excellent light transmittance at wavelengths of 300 to 1100 nm. Furthermore, polyvalent oxides, such as Sb₂O₃ and As₂O₃, generate oxygen while being melted, so that air bubbles scattering light arise in the glass to decrease the light transmittance of the glass. Therefore, the glass material according to the present invention is substantially free of Sb₂O₃ and As₂O₃. Herein, “substantially free of” means that no amount of Sb₂O₃ and As₂O₃ is deliberately incorporated into the glass and does not mean to completely exclude even unavoidable impurities. More objectively, this means that the content of these components including impurities is less than 0.1%.

The glass material according to the present invention preferably contains, in terms of oxide by mole %, over 25 to 40% Tb₂O₃.

The glass material according to the present invention preferably further contains, in % by mole, 0 to below 45% SiO₂, 0 to below 25% B₂O₃, 0 to 50% P₂O₅, and over 0 to below 75% SiO₂+B₂O₃+P₂O₅. As used herein, “SiO₂+B₂O₃+P₂O₅” means the total content of SiO₂, B₂O₃, and P₂O₅.

The glass material according to the present invention preferably further contains, in % by mole, 0 to below 75% Al₂O₃.

The glass material according to the present invention preferably has a light transmittance of 60% or more at a wavelength of 633 nm and an optical path length of 1 mm.

The glass material according to the present invention preferably has a glass transition point of 650 to 1000° C.

The glass material according to the present invention can be used as a magneto-optical element. For example, the glass material according to the present invention can be used as a Faraday rotator which is a type of magneto-optical element. The use of the glass material for the above application makes it easy for the glass material to be given the effect of the present invention.

A glass material according to the present invention contains, in terms of oxide by mole %, 5 to 40% Tb₂O₃, is substantially free of Sb₂O₃ and As₂O₃, and has a light transmittance of 60% or more at a wavelength of 633 nm and an optical path length of 1 mm.

A method for manufacturing a glass material according to the present invention is a method for manufacturing the above-described glass material and includes the step of thermally treating a precursor glass in an inert atmosphere or a reducing atmosphere.

As described previously, in a magnetic material containing Tb, Tb⁴+ has broad light absorption within a range of wavelengths from. 300 to 1100 nm, which causes a decrease in light transmittance. To cope with this, a precursor glass containing Tb is first produced and the precursor glass is then thermally treated in an inert atmosphere or a reducing atmosphere, so that Tb can be reduced or the oxidation of Tb can be inhibited. As a result, the proportion of Tb³+ to the total amount of Tb in the glass material can be increased to thus increase the light transmittance at wavelengths of 300 to 1100 nm.

In the method for manufacturing a glass material according to the present invention, the precursor glass is preferably thermally treated at a temperature of (a glass transition point minus 150° C.) to (the glass transition point plus 150° C.). By doing so, the proportion of Tb³+ to the total amount of Tb in the precursor glass can be efficiently increased.

In the method for manufacturing a glass material according to the present invention, the precursor glass is preferably thermally treated at over 650° C. to 1000° C.

### Advantageous Effects of Invention

The present invention enables provision of a glass material having high light transmittance at operating wavelengths.

### DESCRIPTION OF EMBODIMENTS

A glass material according to the present invention contains, in terms of oxide by mole %, 5 to 40% Tb₂O₃, preferably 6 to 40% Tb₂O₃, more preferably 7 to 40% Tb₂O₃, still more preferably 8 to 40% Tb₂O₃, yet still more preferably 15 to 40% Tb₂O₃, even more preferably 20 to 40% Tb₂O₃, even yet more preferably over 25 to 40% Tb₂O₃, even yet still more preferably 30 to 40% Tb₂O₃, and particularly preferably 31 to 40% Tb₂O₃. If the content of Tb₂O₃ is too small, the Faraday effect is likely to be small. On the other hand, if the content of Tb₂O₃ is too large, vitrification is less likely to occur. Note that Tb in the glass is present in a trivalent state or a quadrivalent state, but all of these states of Tb are represented as Tb₂O₃ in the present invention.

In the glass material according to the present invention, the proportion of Tb³+ to the total amount of Tb is, in % by mole, preferably 55% or more, more preferably 60% or more, still more preferably 70% or more, yet still more preferably 80% or more, even yet still more preferably 90% or more, and particularly preferably 95% or more. If the proportion of Tb³+ to the total amount of Tb is too small, the light transmittance at wavelengths of 300 to 1100 nm is likely to decrease.

If the glass material according to the present invention contained Sb₂O₃ and As₂O₃, air bubbles scattering light would be likely to arise in the glass and the light transmittance of the glass would thus be likely to be decreased. Therefore, the glass material according to the present invention is substantially free of Sb₂O₃ and As₂O₃.

The glass material according to the present invention may contain, in addition to Tb₂O₃, the following components. In the following description of the contents of components, “%” refers to “% by mole” unless otherwise specified.

SiO₂ is a component for forming a glass network and widening the vitrification range. Furthermore, SiO₂ is also a component for increasing the glass transition point. However, this component does not contribute to increasing the Verdet constant. Therefore, if the content thereof is too large, a sufficient Faraday effect is less likely to be achieved. Hence, the content of SiO2 is preferably 0 to 50%, more preferably 0 to below 45%, still more preferably 0 to 40%, yet still more preferably 0 to 30%, even yet still more preferably 0 to 20%, and particularly preferably 1 to 9%.

B₂O₃ is a component for forming a glass network and widening the vitrification range. Furthermore, B₂O₃ is also a component for stabilizing the glass and makes the glass material less likely to be devitrified during thermal treatment. However, B₂O₃ does not contribute to increasing the Verdet constant. Therefore, if its content is too large, a sufficient Faraday effect is less likely to be achieved. Hence, the content of B₂O₃ is preferably 0 to 50%, more preferably 0 to 40%, still more preferably 0 to 30%, yet still more preferably 0 to below 25%, even yet still more preferably 0 to 20%, and particularly preferably 1 to 9%.

P₂O₅ is a component for forming a glass network and widening the vitrification range. Furthermore, P₂O₅ is also a component for stabilizing the glass and makes the glass material less likely to be devitrified during thermal treatment. However, P₂O₅ does not contribute to increasing the Verdet constant. Therefore, if its content is too large, a sufficient Faraday effect is less likely to be achieved. Hence, the content of P2O5 is preferably 0 to 50%, more preferably 0 to 40%, still more preferably 0 to 30%, yet still more preferably 0 to below 25%, even yet still more preferably 0 to 20%, and particularly preferably 1 to 9%.

The content of SiO₂+B₂O₃+P₂O₅ is preferably over 0 to below 75%, more preferably 2 to 74%, and particularly preferably 2 to 70%. If the content of SiO₂+B₂O₃+P₂O₅ is too small, the glass material is likely to be devitrified when being thermally treated. On the other hand, if the content of SiO₂+B₂O₃+P₂O₅ is too large, a sufficient Faraday effect is less likely to be achieved.

Al₂O₃ is a component for forming a glass network and widening the vitrification range. Furthermore, Al₂O₃ is also a component for increasing the glass transition point. However, Al₂O₃ does not contribute to increasing the Verdet constant. Therefore, if its content is too large, a sufficient Faraday effect is less likely to be achieved. Hence, the content of A1203 is preferably 0 to below 75%, more preferably 1 to 70%, still more preferably 3 to 60%, yet more preferably 3 to 50%, yet still more preferably 3 to 40%, even more preferably 3 to 30%, even still more preferably 3 to 20%, even yet still more preferably 3 to 10%, and particularly preferably 3 to 7%.

La₂O₃, Gd₂O₃, Y₂O₃, and Yb₂O₃ have the effect of making vitrification stable. However, an excessive large content thereof contrariwise makes the glass raw material less likely to vitrify. Therefore, the content of each of La₂O₃, Gd₂O₃, Y₂O₃, and Yb₂O₃ is preferably 10% or less and particularly preferably 5% or less.

Dy₂O₃, Eu₂O₃, and Ce₂O₃ make vitrification stable and contribute to increasing the Verdet constant. However, an excessive large content thereof contrariwise makes the glass raw material less likely to vitrify. Therefore, the content of each of Dy₂O₃, Eu₂O₃, and Ce₂O₃ is preferably 15% or less and particularly preferably 10% or less. Note that Dy, Eu, and Ce in the glass are present in a trivalent state or a quadrivalent state, but all of these states are represented as Dy₂O₃, Eu₂O₃ and Ce₂O₃, respectively, in the present invention.

MgO, CaO, SrO, and BaO have the effect of making vitrification stable and increasing the chemical durability. However, these components do not contribute to increasing the Verdet constant. Therefore, if the content of them is too large, a sufficient Faraday effect is less likely to be achieved. Hence, the content of each of these components is preferably 0 to 10% and particularly preferably 0 to 5%.

GeO₂ is a component for increasing the glass formation ability. However, GeO₂ does not contribute to increasing the Verdet constant. Therefore, if its content is too large, a sufficient Faraday effect is less likely to be achieved. Hence, the content of GeO₂ is preferably 0 to 15%, more preferably 0 to 10%, and particularly preferably 0 to 9%.

Ga₂O₃ has the effect of increasing the glass formation ability and widening the vitrification range. However, an excessive large content thereof is likely to cause devitrification. Furthermore, Ga₂O₃ does not contribute to increasing the Verdet constant. Therefore, if its content is too large, a sufficient Faraday effect is less likely to be achieved. Hence, the content of Ga₂O₃ is preferably 0 to 6% and particularly preferably 0 to 5%.

Fluorine has the effect of increasing the glass formation ability and widening the vitrification range. However, if its content is too large, fluorine volatilizes during melting, which may cause a composition variation or may have an influence on vitrification. Therefore, the content of fluorine (in terms of F₂) is preferably 0 to 10%, more preferably 0 to 7%, and particularly preferably 0 to 5%.

The glass material according to the present invention exhibits good light transmission properties within a range of wavelengths from 300 to 1100 nm. Specifically, the transmittance at a wavelength of 633 nm and an optical path length of 1 mm is 60% or more, preferably 65% or more, more preferably 70% or more, still more preferably 75% or more, and particularly preferably 80% or more. Furthermore, the transmittance at a wavelength of 532 nm and an optical path length of 1 mm is preferably 30% or more, more preferably 50% or more, still more preferably 60% or more, yet still more preferably 70% or more, and particularly preferably 80% or more. Moreover, the transmittance at a wavelength of 1064 nm and an optical path length of 1 mm is preferably 60% or more, more preferably 70% or more, still more preferably 75% or more, and particularly preferably 80% or more.

The glass transition point of the glass material according to the present invention is preferably 650 to 1000° C., more preferably 670 to 950° C., and particularly preferably 700 to 900° C. If the glass transition point is too low, devitrification is likely to occur during thermal treatment. On the other hand, if the glass transition point is too high, the glass structure is less likely to be changed even by thermal treatment, so that Tb cannot be sufficiently reduced and the proportion of Tb³+ to the total amount of Tb is likely to be small.

Next, a description will be given of a method for manufacturing a glass material according to the present invention. The method for manufacturing a glass material according to the present invention includes the step of thermally treating an obtained precursor glass in an inert atmosphere or a reducing atmosphere.

The precursor glass is obtained by weighing raw materials to give a desired composition, mixing them well to prepare a glass raw material, melting the glass raw material at 800 to 1600° C., and cooling the melt. There is no limitation placed on the melting technique. The raw materials may be loaded into a platinum crucible and heated to melting in an electric furnace or a technique may be used in which a raw material block is heated to melting by laser irradiation or other methods while being held levitated in air (containerless levitation technique). Examples of the raw material block include a body obtained by forming powdered raw materials into a single piece by press forming or other processes, a sintered body obtained by forming powdered raw materials into a single piece by press forming or other processes and then sintering the single piece, and an aggregate of crystals having the same composition as a desired glass composition.

There is no limitation placed on the melting atmosphere, and it may be an air atmosphere, but it is preferably an inert atmosphere or a reducing atmosphere from the viewpoint of effectively increasing the proportion of Tb³+ to the total amount of Tb. Examples of the inert gas to be used include nitrogen, argon, helium, and carbon dioxide and examples of the reducing gas to be used include carbon monoxide and hydrogen. In consideration of safety, the reducing atmosphere is preferably an atmosphere in which a mixture gas of a reducing gas and an inert gas is used. From the viewpoint of effectively increasing the proportion of Tb³+ to the total amount of Tb, a reducing atmosphere is more preferred and an atmosphere of a mixture gas of hydrogen and an inert gas is particularly preferred also in view of safety.

The method for producing a precursor glass is not limited to the method of melting the glass raw material and then cooling the melt and, for example, a precursor glass may be produced by the sol-gel method. Alternatively, a precursor glass may be produced by various thin film production processes, such as the CVD (chemical vapor deposition) process, the PVD (physical vapor deposition) process, and the PLD (pulsed laser deposition) process.

Next, the obtained precursor glass is thermally treated in an inert atmosphere or a reducing atmosphere. Examples of the inert gas to be used include nitrogen, argon, helium, and carbon dioxide and examples of the reducing gas to be used include carbon monoxide and hydrogen. In consideration of safety, the reducing atmosphere is preferably an atmosphere in which a mixture gas of a reducing gas and an inert gas is used. From the viewpoint of effectively increasing the proportion of Tb³+ to the total amount of Tb, a reducing atmosphere is more preferred and an atmosphere of a mixture gas of hydrogen and an inert gas is particularly preferred also in view of safety.

The thermal treatment temperature is preferably not less than (the glass transition point minus 150° C.) of the precursor glass and particularly preferably not less than (the glass transition point minus 100° C.) thereof. If the thermal treatment temperature is too low, the effect of increasing the proportion of Tb³+ to the total amount of Tb is less likely to be achieved. On the other hand, if the thermal treatment temperature is too high, devitrification is likely to occur. Therefore, the thermal treatment temperature is preferably not more than (the glass transition point plus 150° C.) and particularly preferably not more than (the glass transition point minus 100° C.) Specifically, the thermal treatment temperature is preferably over 650 to 1000° C., more preferably 660 to 980° C., still more preferably 670 to 960° C., yet still more preferably 700 to 940° C., and particularly preferably 750 to 900° C. Note that the glass transition point of the precursor glass is equal to the glass transition point of the glass material described above.

The thermal treatment time is preferably not less than 0.5 hours and particularly preferably not less than an hour. If the thermal treatment time is too short, the effect of increasing the proportion of Tb³+ to the total amount of Tb is less likely to be achieved. On the other hand, the upper limit of the thermal treatment time is not particularly placed, but an excessively long thermal treat time does not provide an enhanced effect and leads to energy loss. Therefore, the thermal treatment time is preferably not more than 100 hours, more preferably not more than 50 hours, and particularly preferably not more than 10 hours.

### EXAMPLES

The present invention will be described below with reference to examples but the present invention is not at all limited by these examples.

### Example 1

(Production of Precursor Glass)

First, a glass raw material formulated to have a composition of, in % by mole, 20% Tb₂O₃, 15% SiO₂, 30% Al₂O₃, and 35% CaO was put into a platinum crucible and melted at 1500° C. for an hour. Subsequently, the molten glass was allowed to flow on a metal plate and cooled to become solidified, thus obtaining a precursor glass (with a glass transition point of 748° C.). The obtained precursor glass took on a brown color and exhibited a light transmittance of 55% at 633 nm.

(Production of Glass Material)

Next, the precursor glass was thermally treated at 800° C. for three hours in an atmosphere of 4%-H₂/N₂ (a mixed gas of, in % by volume, 4% H₂ and 96% N₂), thus obtaining a glass material.

The proportion of Tb³+ to the total amount of Tb in the obtained glass material was 89% and the light transmittance of the glass material at 633 nm was 83%.

### Example 2

(Production of Precursor Glass)

First, raw materials formulated to have a composition of, in % by mole, 30% Tb₂O₃, 60% Al₂O₃, and 10% B₂O₃ were press-formed and sintered at 1200° C. for six hours, thus producing a block of glass raw material. Subsequently, the block of glass raw material was coarsely ground into 0.5 g small pieces. Using the obtained small piece of the block of glass raw material, a precursor glass (with a diameter of approximately 4 mm and a glass transition point of 843° C.) was produced by a containerless levitation technique. Note that dry air was used as a gas for the levitation and a 100 W CO₂ laser oscillator was used as a heat source.

(Production of Glass Material)

The precursor glass was thermally treated at 830° C. for three hours in an atmosphere of 4%-H₂/N₂, thus obtaining a glass material. The proportion of Tb³+ to the total amount of Tb in the obtained glass material was 85% and the light transmittance of the glass material at 633 nm was 82%.

### Example 3

(Production of Precursor Glass)

First, raw materials formulated to have a composition of, in % by mole, 39% Tb₂O₃, 20% SiO₂, 24% B₂O₃, 7% P₂O₅, and 10% Al₂O₃ were press-formed and sintered at 800° C. for six hours, thus producing a block of glass raw material. Subsequently, the block of glass raw material was coarsely ground into 0.5 g small pieces. Using the obtained small piece of the block of glass raw material, a precursor glass (with a diameter of approximately 4 mm and a glass transition point of 865° C.) was produced by a containerless levitation technique. Note that N₂ gas was used as a gas for the levitation and a 100 W CO₂ laser oscillator was used as a heat source.

(Production of Glass Material)

The precursor glass was thermally treated at 860° C. for ten hours in an atmosphere of 4%-H₂/N₂, thus obtaining a glass material. The proportion of Tb³+ to the total amount of Tb in the obtained glass material was 92% and the light transmittance of the glass material at 633 nm was 82%.

### Comparative Example 1

The precursor glass produced in Example 1 was thermally treated at 800° C. for three hours in an air atmosphere, thus obtaining a glass material. The proportion of Tb³+ to the total amount of Tb in the obtained glass material was 45% and the light transmittance of the glass material at 633 nm was as low as 43%.

### Comparative Example 2

The precursor glass produced in Example 1 was thermally treated at 500° C. for three hours in an atmosphere of 4%-H₂/N₂, thus obtaining a glass material. The proportion of Tb³+ to the total amount of Tb in the obtained glass material was 42% and the light transmittance of the glass material at 633 nm was as low as 43%.

### Comparative Example 3

The precursor glass produced in Example 1 was thermally treated at 1100° C. for three hours in an atmosphere of 4%⁻H₂/N₂, thus obtaining a glass material. The obtained glass material had be devitrified.

The glass transition point was measured with a macro differential thermal analyzer. Specifically, in a chart obtained by measuring each glass material up to 1000° C. with the macro differential thermal analyzer, the value of a first inflection point was considered as the glass transition point.

The proportion of Pb³+ to the total amount of Tb was measured with an X-ray photoelectron spectroscopic analyzer (XPS). Specifically, as for the obtained glass material, the proportion of Tb³+ to the total amount of Tb was calculated from the peak intensity ratio of each Tb ion measured with the X-ray photoelectron spectroscopic analyzer.

The light transmittance was measured with a spectro-photometer (UV-3100 manufactured by Shimadzu Corporation). Specifically, the obtained glass material was polished to have a thickness of 1 mm, alight transmittance curve was obtained by measuring the light transmittances of the polished glass material at wavelengths between 300 nm and 1400 nm, and the light transmittance at a wavelength of 633 nm was read from the obtained light transmittance curve. The light transmittance is the external light transmittance including reflection.

1. A glass material containing, in terms of oxide by mole %, 5 to 40% Tb₂O₃ and being substantially free of Sb₂O₃ and As₂O₃, wherein a proportion of Tb³+ to a total amount of Tb is 55% by mole or more.

2. The glass material according to claim 1, containing, in terms of oxide by mole %, over 25 to 40% Tb₂O₃.

3. The glass material according to claim 1, further containing, in % by mole, 0 to below 45% SiO₂, 0 to below 25% B₂O₃, 0 to 50% P₂O₅, and over 0 to below 75% SiO₂+B₂O₃+P₂O₅.

4. The glass material according to claim 1, further containing, in % by mole, 0 to below 75% Al₂O₃.

5. The glass material according to claim 1, having a light transmittance of 60% or more at a wavelength of 633 nm and an optical path length of 1 mm.

6. The glass material according to claim 1, having a glass transition point of 650 to 1000° C.

7. The glass material according to claim 1, being used as a magneto-optical element.

8. The glass material according to claim 7, being used as a Faraday rotator.

9. A glass material containing, in terms of oxide by mole %, 5 to 40% Tb₂O₃, being substantially free of Sb₂O₃ and As₂O₃, and having a light transmittance of 60% or more at a wavelength of 633 nm and an optical path length of 1 mm.

10. A method for manufacturing the glass material according to claim 1, the method comprising the step of thermally treating a precursor glass in an inert atmosphere or a reducing atmosphere.

11. The method for manufacturing the glass material according to claim 10, wherein the precursor glass is thermally treated at a temperature of (a glass transition point minus 150° C.) to (the glass transition point plus 150° C.).

12. The method for manufacturing the glass material according to claim 10, wherein the precursor glass is thermally treated at over 650° C. to 1000° C.
